(19) United States
(12) Patent Application Publication
(10) Pub. No.: US 2026/0134275 A1
(43) Pub. Date: May 14, 2026

(54) ITEM TAGGING AND COHORT FORMATION USING GENERATIVE MODELS

(71) Applicant: Walmart Apollo, LLC, Bentonville, AR (US)

(72) Inventors: Akash Daxeshkumar Patel, Milpitas, CA (US); Abhinav Prakash, Milpitas, CA (US); Yokila Arora, San Jose, CA (US); Sushant Kumar, San Jose, CA (US); Kannan Achan, Saratoga, CA (US)

(21) Appl. No.: 18/945,667

(22) Filed: Nov. 13, 2024

(51) Int. Cl. G06N 3/08

(52) U.S. Cl. CPC G06N 3/08

(57) ABSTRACT

Examples provide a system and method for automatically tagging items and forming item-level user cohorts using a generative artificial intelligence (GenAI) model. A GenAI model generates item-level persona labels for a subset of untagged items sampled from a category of items. An item-level persona reflects user behaviors and/or preferences associated with specific items and types of items. The labeled item data, including the persona identification (ID) label, is used to train a deep neural net (DNN) labeling model to label untagged items with persona IDs for item-level personas. Customized item recommendations for each tagged item is mapped to a user cohort and used to generate item recommendations customized at the item-level. The DNN labeling model is periodically tested, evaluated, and retrained using sample tagged item data from the GenAI model to reduce the DNN model error rate and improve accuracy of the DNN model persona predictions.

### BACKGROUND

It is frequently desirable for retailers to customize product promotions and other content presented to users based on each user's preferences and interests. In some cases, users can be placed into one or more categories based on the user's interests, previous purchases, search history, and other user activity to improve customization of products and content provided to users. The users in each group or category can be matched with items that are manually tagged or classified for each different category. However, manually classifying items into numerous possible categories is time consuming and not scalable for large numbers of items.

### SUMMARY

Some examples provide a system and method for multi-level item tagging and cohort mapping. A deep neural network (DNN) model is trained to label untagged item data using training data generated by the Gen AI model. The training data includes sample tagged item data associated with a subset of items from a plurality of items. The sample tagged item data includes item data for each item in the subset of items labeled with a persona identifier (ID) corresponding to an item-level persona. An untagged item is detected in the plurality of items associated with a catalog. A closest item-level persona is predicted from a plurality of item-level personas associated with a product type persona of the untagged item based on item data associated with the untagged item, the item data including an item description for the untagged item. A persona label including a persona ID of the closest item-level persona is assigned to the untagged item. An item assigned the persona ID is mapped to each user in a corresponding cohort of users having a same persona ID.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts an example block diagram illustrating a system utilizing a generative artificial intelligence (GenAI) model for item tagging using item-level personas for more granular cohort formation.

FIG. 2 depicts a block diagram illustrating a system for tagging items using personas.

FIG. 3 depicts a block diagram illustrating an example label manager component for tagging items with item-level persona labels for cohort formation and item-to-user mapping.

FIG. 4 depicts a block diagram illustrating an example item taxonomy for creating item-level cohorts based on user personas.

FIG. 5 depicts a flow chart illustrating an example operation of the computing device to assign item-level persona labels to untagged items in a catalog of items.

FIG. 6 depicts a flow chart illustrating an example operation of the computing device to retrain a deep neural net (DNN) model for tagging items.

FIG. 7 depicts a flow chart illustrating an example operation of the computing device to generate customized item recommendations using item-level cohorts.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

A persona is a group or classification for users and/or items created based on user shopping-related behaviors, such as online browsing history, purchase history, items placed into a shopping cart, etc. Items can be classified based on the type of product. For example, grocery items can be classified according to product types such as vegetarian, organic, breakfast foods, desserts, convenience foods, fruit, vegetables, etc. In another example, sports-related items can be classified at a product type (PT) level based on the type of sport, such as football, baseball, soccer, basketball, etc. However, PT-level persona definition is limiting and does not personalize at a granular-level. For example, creating personas for sports league teams require sophisticated item understanding, as the products for sports league teams would span across many PTs. There typically is not any field in item meta-data that indicates whether an item should be a part of a particular team. Simply classifying an item as a sports-related category or even a slightly more specific category for a specific sport (e.g., football) would result in sports-related products for any and all teams of that sport being recommended to a user. This would likely be unhelpful to a user and possibly hinder the user rather than be of assistance due to the lack of specificity available in the PT level personas. This can further result in wasted system resources generating item recommendations which are unlikely to result in increased sales or customer satisfaction.

GenAI models, including large language models (LLM), can be used to label items in a catalog. However, each item that needs to be labeled by the GenAI model results in another call on the GenAI model which is expensive and resource intensive. Moreover, this solution is only feasible for very small numbers of items due to the impracticality of calling the GenAI model for each and every individual type of item and/or variety of item. Thus, this solution is unscalable, impractical and cost prohibitive where a majority of retailers have inventories and item assortments available for viewing and/or purchase that includes thousands of different items.

Referring to the figures, examples of the disclosure enable multi-level item tagging and item-level cohort formation for provision of more accurate and granular item recommendations to users. In some examples, a label manager utilizes one or more machine learning (ML) models to assign items in a catalog to one or more user personas. A user persona is a category or classification of a type of user behavior or user interest. For example, a user persona could include sports, football, or a more specific category, such as a specific football team. Items are mapped to groups (cohorts) of users based on the assigned personas for each user. This enables improved accuracy and reliability of item recommendations for targeted promotions, customization of a homepage or application, and/or notifications provided to a user regarding new products and deals associated with products predicted to be of interest to the user.

Other embodiments provide tagging of items and formation of item-level cohorts of users using a generative artificial intelligence (GenAI) model to train a deep neural net (DNN) labeler model. The GenAI model analyzes item data for a sample of untagged items. An untagged item is an item which does not have a persona label identifying an item-level persona for the item. The GenAI model analyzes an item description for each item in the subset of items and the description for each item-level persona in a subset of personas. The GenAI model identifies the best persona from the subset of personas. The best persona is a persona having a description which most closely resembles the description of the item. This enables more accurate and reliable mapping of items to users based on the personas assigned to each item and each user while reducing the number of calls to the GenAI model.

In other examples, the labeled training data generated by a GenAI model is used to train a DNN model to predict the appropriate item-level persona for each untagged item in a set of untagged items without making any additional calls on the GenAI model. This further enables reduced system resource usage where the trained DNN model is enabled to label untagged items with a persona identifier (ID) while utilizing fewer resources than would be consumed by the GenAI model performing the same task.

Still other embodiments enable retraining a trained DNN model to label untagged items with item-level personas using GenAI model generated labeled training data, including sample tagged item data, to further refine and improve accuracy and reliability of the DNN model performance tagging items with item-level personas. This further reduces system resource usage while further reducing the error rate associated with automatic labeling of items.

Aspects of the disclosure further enable automatic labeling of untagged items with item-level personas for use in granular cohort formation and improved customization of item recommendations to users in a scalable manner enabling easy integration of new products and changing item assortments associated with product inventories and online product catalogs. The automatic labeling of sampled items from a catalog enables the DNN to perform granular cohort formation for improved accuracy of predictions and product recommendations.

The computing device operates in an unconventional manner by using training data, including sample tagged item data, generated by a GenAI model to train a DNN model for predicting item-level personas associated with items in a catalog of items with fewer calls on the GenAI model where the GenAI model is only called upon to label small subsets of the items in the item catalog. In this manner, the computing device is used in an unconventional way by only submitting small subsets of items to the GenAI model for labeling, which is subsequently used for training, testing, and retraining the DNN labeler model. Thus, rather than rely on the GenAI model for all item labeling, the more reliable GenAI model is instead used to train and test a DNN model to perform the bulk of the item labeling, which is less resource intensive and far more scalable. This further allows improved granularity in item-to-cohort mapping by enabling more specific item-level persona labeling rather than only the broader PT level persona labeling while reducing processor load, conserving memory, and reducing network bandwidth usage by relying primarily on the DNN model to perform labeling but enabling the GenAI model to periodically test and retrain the DNN model to reduce errors and ensure results produced by the DNN model are as reliable as the labeling of the more sophisticated GenAI model. In other words, the system is able to utilize the GenAI model in conjunction with the DNN model to leverage the reliability of the GenAI model to ensure accuracy of all labeling of items without actually requiring the GenAI model to label each and every item in the catalog, thereby improving the functioning of the underlying computing device.

Other embodiments enable more accurate and customized recommendations of items to users, including customized webpages, product notifications via email and text messages, customization of home page content presented to the user via an application on a user device, or other user interface (UI) device. The recommendations are customized at a more granular level for improved relevance to the user. This enables improved user efficiency via the UI interface and increased user interaction performance.

In some examples, the system creates hyper-personalized user personas by creating a sophisticated persona understanding at an item-level. Granular personalization improves relevancy of content and improves customer experience where item-level persona understanding is not available via a typical product catalog. Moreover, utilization of GenAI models reduces the expenses associated with manual labeling while further reducing occurrence of errors which frequently occurs during manual labeling.

In this manner, the system provides a flexible and dynamic framework fusing LLM and DNN-based ML models for creating granular personas at an item-level. The system provides an innovative sampling-based model training methodology to improve scalability and cost-effectiveness. Leveraging a GenAI LLM-as-a-labeler overcomes manual labeling problems, such as the expense and error rates associated with manual labeling. The label manager can be deployed on multiple persona use cases and is easily extendable to new use cases, enabling scalability and flexibility.

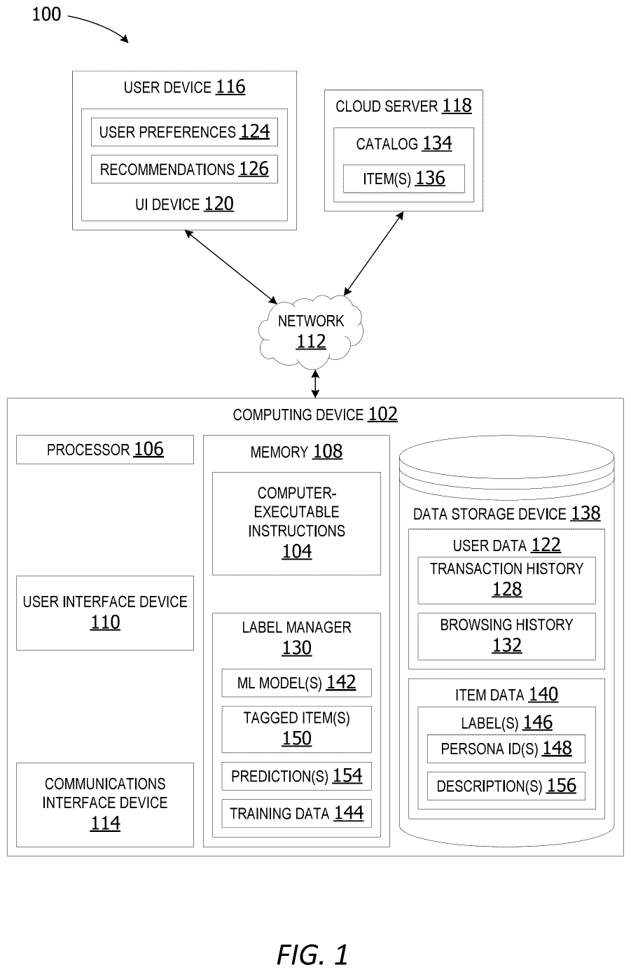

Referring again to FIG. 1, which illustrates a generative artificial intelligence (GenAI) model tagging or labeling data using item-level personas for more granular cohort formation. In the example of FIG. 1, the computing device 102 represents any device executing computer-executable instructions 104 (e.g., as application programs, operating system functionality, or both) to implement the operations and functionality associated with the computing device 102. The computing device 102, in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples includes a user interface device 110.

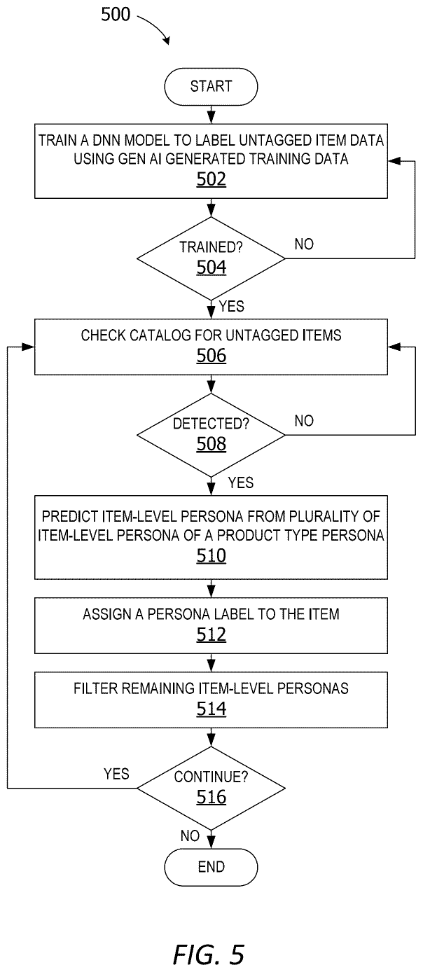

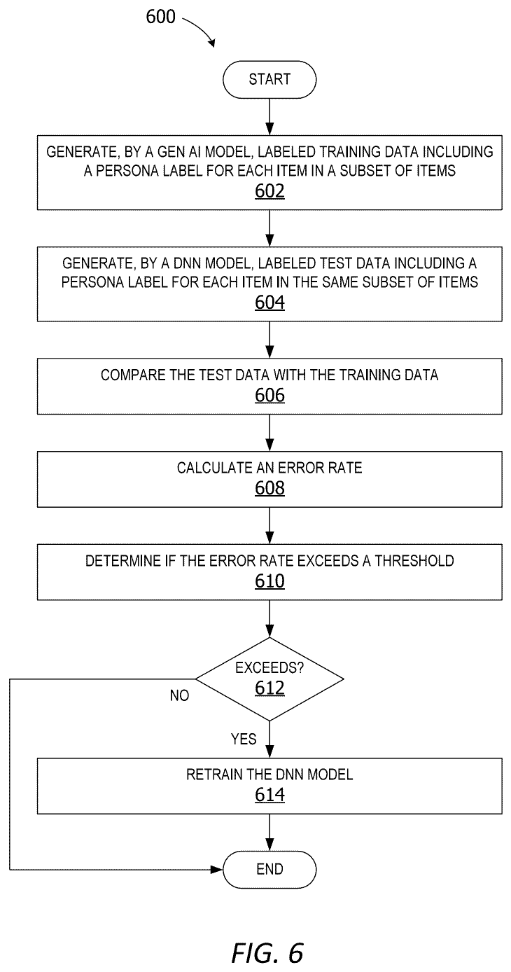

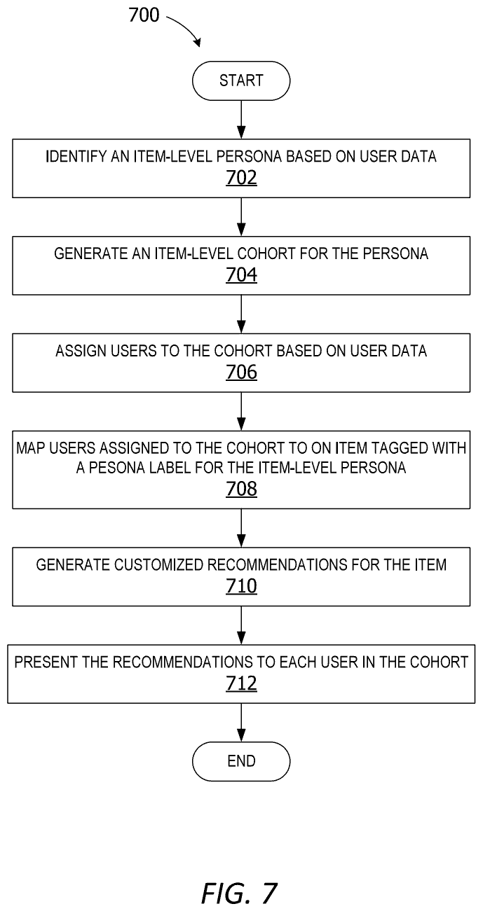

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some examples, the processor 106 is programmed to execute instructions such as those illustrated in the figures (e.g., FIG. 5, FIG. 6, and FIG. 7).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud, such as an e-commerce website or an online shopping application associated with a merchant or retail facility.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device 116 and/or a cloud server 118, can occur using any protocol or mechanism over any wired or wireless connection. In some examples, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface (UI) device 120.

The UI device 120 is a user interface for presenting data to a user and/or receiving input from the user, such as, but not limited to, the user interface device 110. In some examples, the UI device 120 is used to obtain user data 122 from a user, such as, but not limited to, user preference 124. User preferences 124 include any type of preferences of a user, such as preferred item brands, colors, product sizes, apparel styles, entertainment genres, favorite music, appearance/layout of a homepage, communication preferences, or any other preferences. The UI device 120 can also be used to present output to a user, such as item recommendations 126. A recommendation is a notification of an item predicted to be of interest to a user based on the user preferences 124 and/or other user behavior, such as previous item purchases recorded in a user's transaction history 128 and/or browsing history 132 identifying items the user has previously viewed while browsing through one or more item(s) 136 available in an item catalog.

The cloud server 118 is a logical server providing services to the computing device 102 or other clients, such as, but not limited to, the user device 116. The cloud server 118 is hosted and/or delivered via the network 112. In some non-limiting examples, the cloud server 118 is associated with one or more physical servers in one or more data centers. In other examples, the cloud server 118 is associated with a distributed network of servers.

In some examples, the cloud server 118 optionally stores data remotely from the computing device 102. In this example, data stored on the cloud server 118 optionally includes data associated with one or more item(s) 136 in a catalog 134 of items associated with an online shopping service and/or a retail facility providing item data associated with items available for purchase or order via a website or application on the user device 116. In this example, a label manager 130 software component on the computing device 102 accesses information associated with item(s) 136 in the catalog 134 via the network 112. However, the examples are not limited to storing data associated with a catalog of items on a cloud server or other remote data storage device. In other examples, the catalog 134 is stored locally on a data storage device, such as, but not limited to, the data storage device 138.

The data storage device 138, in some examples, is a device for storing data, such as, but not limited to user data 122 associated with one or more users and/or item data 140 associated with one or more item(s) 136 in the catalog 134. The item data 140 includes a title or name of each item and an item description describing each item. The item data can include data associated with tagged items and/or untagged items. A tagged item is an item having a persona label identifying a persona. A persona can include a broad product type (PT) persona and/or a more granular item-level persona. An item-level persona can optionally also include one or more sub-category personas. In other words, each PT persona can have two or more sub-categories referred to as item-level personas. For example, a PT persona for “sports” or “sports memorabilia” can include a more granular sub-category persona for specific sports, such as “football” or “soccer.” The persona for “football” can include one or more item-level personas for specific football teams, such as the “Longhorns” or the “Cowboys.” An item-level persona for a specific team can include additional sub-category personas that are still more specific, such as “clothing/apparel” or “decorations.”

The data storage device 138 can include one or more different types of data storage devices, such as, for example, one or more rotating disks drives, one or more solid state drives (SSDs), and/or any other type of data storage device. The data storage device 138 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 138 includes a database.

The data storage device 138 in this example is included within the computing device 102, attached to the computing device, plugged into the computing device, or otherwise associated with the computing device 102. In other examples, the data storage device 138 includes a remote data storage accessed by the computing device via the network 112, such as a remote data storage device, a data storage in a remote data center, or a cloud storage.

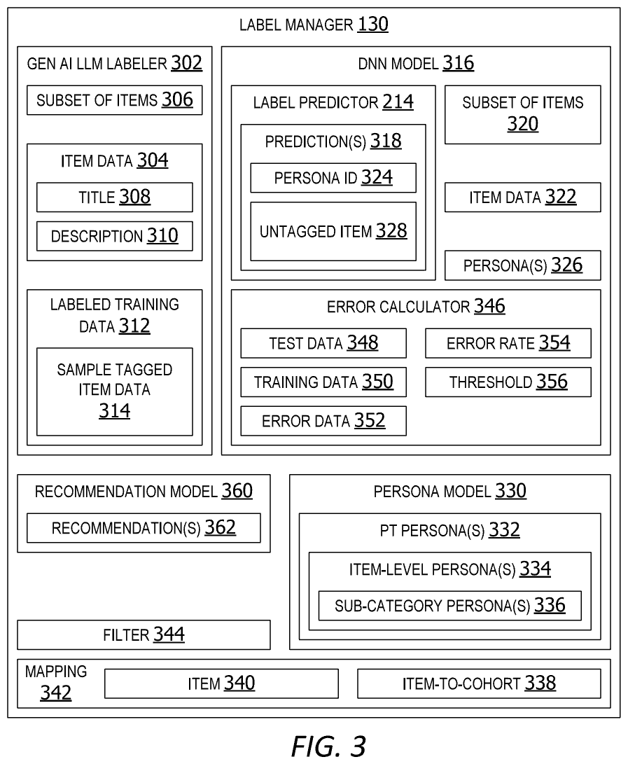

The memory 108 in some examples, stores one or more computer-executable components, such as, but not limited to, the label manager 130. The label manager 130, in some examples, includes one or more machine learning (ML) models 142 for multi-level item tagging and cohort formation. In this example, the ML model(s) 142 includes a GenAI model and a DNN model, as shown in FIG. 3 below.

The label manager 130, when executed by the processor 106 of the computing device 102 in this example, generates labeled training data 144. The training data includes one or more label(s) 146. Each label includes one or more persona identifiers (IDs) 148 for each item in a sample of items obtained from the catalog 134 of item(s) 136. A persona ID identifies a closest item-level persona selected from a plurality of personas. The training data 144 is used to train a DNN model to generate tagged item(s) 150 based on item description(s) 156 for each item in a subset of items from the catalog 134 and a subset of item-level personas associated with a product type persona.

The label manager 130, in some examples, identifies a persona that is closest to an untagged item by comparing the description of the untagged item with the description of the persona. For example, if the untagged item is a pair of name brand running shoes and the persona description includes the same name brand and the words “running shoes” or “athletic shoes,” the system would determine greater semantic similarity than if the persona were for house shoes or for a different brand of running shoes. In some examples, the label manager 130 utilizes a transformer model and natural language processing (NLP) to determine semantic similarity using vectorization of the item description and the persona description. The degree of semantic similarity can be indicated via a ranking or a similarity score. The similarity scoring is used to identify the persona in a set of personas that is the closest or most similar based on the similarity score. However, the examples are not limited to using a semantic similarity scoring.

A description in the item description(s) 156, in other examples, is a text description of an item. The description can include the name of the item and/or other keywords associated with the item. The description can include color, size, dimensions, material composition, age range, care instructions, etc. For example, an item description for a t-shirt can include the name of the item, color of the shirt, size, neckline, type of fabric, washing instructions, etc.

The DNN model analyzes the description(s) 156 for the untagged items. The DNN model makes prediction(s) 154 regarding which item-level (sub-category) persona is the closest (most appropriate) based on the item description for each item. The prediction(s) 154 include one or more predictions regarding which item-level persona in a plurality of item-level personas under consideration is a best match or best fit for an individual item. The DNN model, in some examples, makes a prediction by identifying which persona has a highest similarity score or ranking relative to the other personas in the plurality of personas under consideration. The personas under consideration are personas associated with a PT level persona (category). For example, a PT level persona for donuts can include item-level personas such as, but not limited to, chocolate donuts, glazed donuts, powered donuts, cream filled donuts, etc. The item-level personas can further include additional item-level subcategories. For example, an item-level persona for a specific brand of chocolate donuts can include additional sub-categories for a gluten-free variety, a regular size donuts variety, a mini donuts variety, etc.

In some examples, the DNN model predicts the closest item-level persona or item-level sub-category for a specific item by identifying or selecting the persona having a highest calculated semantic similarity between a description of each persona with the description of the item. The selected or identified item-level persona is the DNN model's prediction for the correct persona and/or persona ID.

The prediction(s) 154 include a persona ID. The persona ID is tagged to an item by adding one or more label(s) 146 to the item data 140 for each item. An untagged item is an item having no persona ID identified in a label for the item and/or no label provided in the item data for the item. Thus, if a PT level persona for football includes an item-level persona for each different football team and item data indicates the item is a shirt with a logo for a “Team X” football team, the item is labeled with a persona ID for the item-level persona corresponding to “Team X”, where “Team X” can be any official name of a football team. The persona IDs for all other football teams are filtered out or otherwise disregarded. In this example, only the item-level persona ID for the most accurate or closest persona is assigned to an item. The item having the item-level persona ID for items related to the “Team X” football team is assigned to a cohort of users having user data indicating a user preference for the team, previous purchases of the “Team X” football team memorabilia or apparel, and/or a previous browsing history indicating the user frequently looks at items having the team name, team colors and/or team logo.

In the above example, the item-level persona can include additional sub-categories. For example, an item-level persona for the “Team X” football team can include a sub-category persona for the “Team X” team colors “orange and white” and/or another sub-category persona for items bearing an image of “Team X's” logo or mascot to further refine the item recommendations based on more specific and granular user shopping preferences.

In some examples, a recommendation model generates recommendations 126 by mapping an item to a cohort using the assigned persona ID. A notification is generated recommending the item to each user in the cohort mapped to the item. The notification can include an email, text message, pop up in a browser, notification added to a home page, or any other type of notification.

In this example, the label manager 130 is implemented on the computing device 102. However, in other embodiments, the label manager 130 is implemented on a cloud server, such as, but not limited to, the cloud server 118.

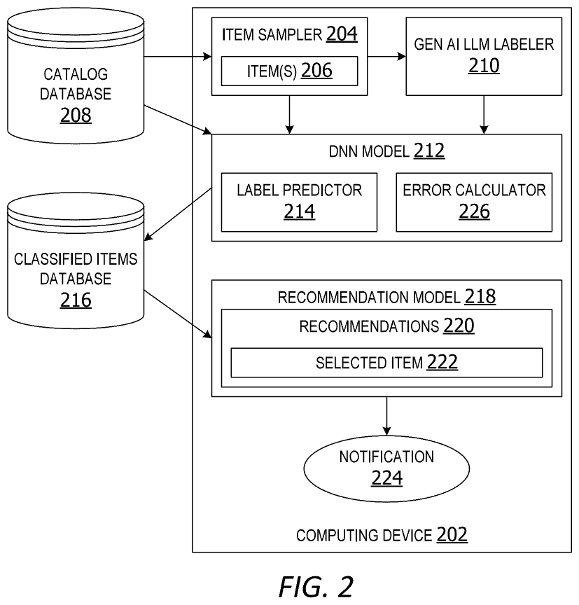

FIG. 2 is an example block diagram illustrating a system 200 for tagging items using personas. In some examples, an item sampler 204 on a computing device 202 samples one or more item(s) 206 from an item catalog database 208. The computing device 202 is a device, such as, but not limited to, the computing device 102 and/or the user device 116 in FIG. 1. The catalog database 208 is a database for storing data, such as, but not limited to, a plurality of items in the catalog 134 in FIG. 1.

The item sampler 204 obtains a sample, or subset of untagged items, from the catalog of items stored on the catalog database 208. The catalog database 208 is any type of database, such as, but not limited to, a relational database. The database is optionally provided via a data storage, such as, but not limited to, the data storage device 138 in FIG. 1. An item in the item catalog includes any type of item. For example, an item can include a food item (comestible), an item of apparel, footwear, pet supplies, office supplies, a seasonal item, a decorative item, a tool, an electronic device, as well as any other type of item. In other examples, an item can include a physical product (goods), services, as well as a combination of goods and services.

A GenAI LLM labeler model 210 receives the subset of items from the item sampler 204. The GenAI LLM model is a ML model, such as, but not limited to, a model in the ML model(s) 142. The GenAI LLM labeler 210 is a ML model capable of understanding and generating natural language text, as well as autonomously producing content. The GenAI LLM labeler 210 generates labeled training data, including sample tagged item data having a persona label identifying an item-level persona for each item in the subset of items. The labeled training data is provided to a DNN model 212.

The DNN model 212 is a ML model, such as, but not limited to, a model in the ML model(s) 142. The DNN model includes a label predictor 214. The DNN model 212 is trained using the labeled training data generated by the GenAI LLM labeler 210.

The label predictor 214 is a software component for predicting an item-level persona for each item in the subset of item(s) 206 provided by the item sampler 204. The DNN model 212 is trained using training data provided by the GenAI LLM labeler 210. The trained DNN model receives item data for untagged items from the catalog database 208. The trained DNN model 212 predicts labels for items in the catalog database 208. In this example, the label predictor 214 generates the predictions identifying the best or most accurate persona from a set of two or more item-level personas. The labeled item data for the tagged items is stored in a classified items database 216. In some examples, an entry for each item in the classified items database 216 includes a persona ID in a persona label added to each item description in the classified items database. The persona ID is used to map a cohort of users to a specific item in the catalog.

In this example, the catalog database 208 and the classified items database 216 are two separate databases. However, in other examples, rather than storing the labeled item data in a separate classified items database 216, the catalog database 208 is updated with the labeled item data. Thus, a single database can be provided for both the tagged item data and the untagged item data. The item sampler identifies untagged items as items in the database lacking a persona ID appended to the item description or otherwise included in a database entry for the item.

A recommendation model 218 is a ML model, such as a ML model in the one or more ML model(s) 142 in FIG. 1. The recommendation model maps a selected item 222 to a cohort of users using the persona ID in the classified items database 216. In some examples, the recommendations 220 include a notification 224 associated with at least one selected item 222. The notification 224 is presented to a user via a user interface, such as, but not limited to, the user interface device 110 and/or the UI device 120 in FIG. 1.

In other examples, the DNN model 212 is retrained or fine-tuned using labeled training data from the GenAI LLM labeler 210. In these examples, the item sampler 204 provides a subset of items to the GenAI LLM labeler 210 and the DNN model 212. In other words, both models receive the same subset of items. The GenAI LLM labeler 210 labels each item in the subset of items with a persona ID for a closest persona selected from a set of item-level personas. The labeled item data from the GenAI LLM labeler is training data.

The DNN model label predictor 214 generates labeled item data including a persona label for each item in the subset of items. The labeled item data is test data used for retraining the DNN model 212. The DNN model compares the training data provided by the GenAI LLM labeler 210 with the test data generated by the DNN model 212 itself. Any errors in the test data is identified. An error occurs where the persona ID predicted by the DNN model differs from the persona ID assigned by the GenAI LLM labeler 210, where the GenAI LLM labeler is assumed to be correct. An error calculator 226 calculates an error rate based on the number and/or frequency of errors in the test data. If the error rate is below a threshold value, the DNN model 212 output is acceptable and the DNN model 212 does not require retraining. If the error rate is equal to or greater than the threshold value (outside an acceptable threshold range), the DNN model is retrained using labeled training data generated by the GenAI LLM labeler 210. This process is repeated iteratively until the DNN model error rate falls within an acceptable threshold range. In this manner, the DNN model can be periodically tested, evaluated, and retrained to ensure high accuracy and reduced error rate in item-to-cohort mapping at the item-level.

Referring now to FIG. 3, an example block diagram illustrating a label manager 130 component for tagging items with item-level persona labels for cohort formation and item to user mapping is shown. In this example, the label manager 130 includes a GenAI LLM labeler 302. The GenAI LLM labeler 302 is a generative AI model, such as, but not limited to, the GenAI LLM labeler 210 in FIG. 2. The GenAI LLM labeler 302 analyzes item data 304 for a subset of items 306 to predict an item-level persona for each item in the subset of items. The item data 304 includes an item title 308 and a description 310. The title is the name of the item. The description is a text description of each item. The predicted persona for each item is tagged to the item data to create sample tagged item data 314. The GenAI LLM labeler 302 generates labeled training data 312 that includes the sample tagged item data 314. The labeled training data 312 is used to train the DNN model 316.

The DNN model 316 is a deep neural net model trained to tag items with a persona ID, such as, but not limited to, a ML model in the ML model(s) 142 in FIG. 1 and/or the DNN model 212 in FIG. 2. Once trained, the DNN model 316 generates predictions 318 for item-level personas which are assigned to each item in a subset of items 320. In some examples, the DNN model label predictor 214 selects the best persona from a plurality of persona(s) 326 which could apply to an untagged item 328. The DNN model adds a label with the persona ID 324 of the predicted persona to the item data 322 for the untagged item. The untagged item then becomes a tagged item.

The persona(s) 326 are generated by a persona model 330. The persona(s) include product type (PT) persona(s) 332. A PT persona is a broad or higher level persona. Each PT persona includes two or more item-level persona(s) 334. An item-level persona is a more specific sub-category of the broader PT persona category. Each item-level persona can optionally include two or more item-level sub-category persona(s) 336 for even greater granularity and specificity when mapping 342 an item 340 to a group of users with an item-to-cohort 338 mapping.

The mapping 342 is used to generate item recommendation(s) 362 by a recommendation model 360. The recommendation model 360 in this example is implemented as part of the label manager 130. However, the embodiments are not limited to a label manager that includes a recommendation model 360. In other examples, the recommendation model 360 is implemented as a separate component from the label manager 130. In these examples, the label manager and the recommendation model 360 can be implemented on the same computing device or separate (different) computing devices.

In some embodiments, the trained DNN model 316 is periodically tested and retrained using labeled training data generated by the GenAI LLM labeler 302. In these examples, the GenAI LLM labeler 302 generates labeled training data 350 for a subset of items. The DNN model generates labeled test data using the same subset of items. The persona labels predicted by the DNN model in the test data 348 are compared to the persona labels generated by the GenAI LLM labeler 302 in the training data 350 with the assumption that the results provided by the GenAI LLM labeler 302 are correct or more likely to be accurate than the results provided by the DNN model 316.

In some examples, an error calculator 346 compares the test data 348 generated by the DNN model with the training data 350 generated by the GenAI LLM labeler 302. Error data 352 is generated. The error data 352 includes an identification of any errors in the test data 348. An error rate 354 is calculated using the error data 352. If the error rate 354 is greater than a threshold 356 or outside an acceptable threshold range, the DNN model 316 is retrained or fine-tuned using labeled training data from the GenAI LLM model 302. The DNN model is retrained iteratively until the error rate reaches an acceptable value.

Other examples optionally include a filter 344. The filter removes unused or low scoring personas from a set of possible item-level personas. In other words, the DNN model predicts a closest item-level persona from a plurality of item-level personas in a same PT level persona category. The low scoring persona sub-categories are filtered or otherwise disregarded.

Given n items (catalog), the label manager obtains a sample k₀<<n items. In other words, a subset of items k₀ are selected from the plurality of items in the catalog. The label manager obtains the GenAI LLM-based labels for the subset of items k₀. A DNN model is built and trained for multilabel classification for k₀ items. Once training is complete, the DNN model obtains a second subset of items k₁ from n−k0 items. The DNN model predicts labels for k₁ items. The label manager identifies misclassified items m₁. The error calculator computes a misclassification error (err). The DNN model is retrained on k0+m1 items. Retraining is performed iteratively until the error converges, err<ε.

User cohorts are user segments that characterize a user based on shopping and web engagement behavior. Personas are a type of user cohort defined based on shopping and web engagement behavior.

The system uses product taxonomy to differentiate user behavior. Personas are assigned based on users'interactions on a set of product types, such as user searches, items viewed by the user, items added to customer carts, and items purchased in transactions. For example, a technology/electronics related persona can include tech-related product types, such as headphones, flash drives (memory sticks), laptops, televisions, etc.

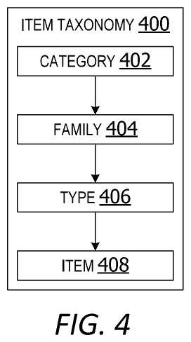

FIG. 4 is an example block diagram illustrating an item taxonomy 400 for creating item-level cohorts based on user personas. The item taxonomy 400 includes a category 402 of items, a family 404 of items, a product type 406 of the items, and an item 408. The item 408 is the most granular and specific level.

In an example, the category 402 can include the category of “electronics.” Other categories could include groceries, pharmacy, garden, hardware, etc. For the electronics category 402, the family 404 level can be “home audio.” The product type 406 in this example can include “headphones.” The item 408 level in this example can include personas such as a specific brand of earbuds. In one example, the item-level persona is a specific brand of wireless earbuds with noise cancelling and BLUETOOTH® enabled headphones.

FIG. 5 is an example flow chart illustrating operation of the computing device to assign item-level persona labels to untagged items in a catalog of items. The process 500 shown in FIG. 5 is performed by a label manager component, executing on a computing device, such as the computing device 102 or the user device 116 in FIG. 1.

The process begins by training a DNN model to label untagged item data using GenAI model generated training data at 502. The DNN model is a machine learning model, such as, but not limited to, the one or more ML model(s) 142 in FIG. 1. The label manager determines whether the DNN model is trained to predict persona labels for untagged items in a catalog of items at 504. If not, the DNN model training continues at 502. The label manger checks the catalog for untagged items at 506. A determination is made whether an untagged item is detected at 508. If yes, the item-level persona is predicted from a plurality of item-level personas of a PT persona at 510. In some examples, the prediction is performed by the trained DNN model. The persona label including the persona ID for the predicted item-level persona is assigned to the item at 512. Remaining item-level personas associated with the PT persona are filtered at 514. A determination is made whether to continue at 516. If yes, the system iteratively executes operations 502 through 516 until a determination is made to discontinue. The process terminates thereafter.

In this example, the label manager checks and/or detects untagged items in the catalog. However, the embodiments are not limited to the label manager checking for untagged items and/or detecting untagged items. In other examples, a sampling model or other component provides untagged items and/or item data associated with untagged items to the label manager for labeling. In still other examples, possible item-level personas are also provided to the label manager by a persona model for use in tagging one or more items with a persona label.

While the operations illustrated in FIG. 5 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 5.

FIG. 6 is an example flow chart illustrating operation of the computing device to retrain a deep neural net (DNN) model for tagging items. The process 600 shown in FIG. 6 is performed by a label manager component, executing on a computing device, such as the computing device 102 or the user device 116 in FIG. 1.

The process begins by generating labeled training data by a GenAI model at 602. The labeled training data includes a persona label for each item in a subset of items. Labeled test data is generated by a DNN model at 604. The labeled test data includes a persona label for each item in the same subset of items. The test data is compared with the training data at 606. An error rate is calculated at 608. The label manager determines if the error rate exceeds a threshold at 610. If the error rate exceeds the threshold at 612, the DNN model is retrained at 614. In some examples, the DNN model is retrained using the labeled training data generated by the GenAI model.

While the operations illustrated in FIG. 6 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 6.

FIG. 7 is an example flow chart illustrating operation of the computing device to generate customized item recommendations using item-level cohorts. The process shown in FIG. 7 is performed by a label manager component, executing on a computing device, such as the computing device 102 or the user device 116 in FIG. 1.

The process begins by identifying an item-level persona based on user data at 702. The user data is data associated with one or more users, such as the user data 122 in FIG. 1. The label manager generates an item-level cohort of users for the persona at 704. Users are assigned to the cohort based on the user data at 706. The label manager maps users assigned to the cohort to an item tagged with a persona label for the item-level persona at 708. The customized recommendations for the item are generated at 710. The customized recommendations include a recommendation for an item associated with an item-level persona for a cohort of users. The recommendations are presented to each user in the cohort at 712. The recommendations can be presented via a web page, such as a merchant website. The recommendations can be transmitted to the user via an email, text message, pop up notification, and/or via customization of a homepage on a merchant application. The process terminates thereafter.

While the operations illustrated in FIG. 7 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 7.

### Additional Examples

The system, in some examples, provides a GenAI LLM model as a labeler for a subset of items. A deep neural net-based (DNN) item mapping model is trained using a batch of LLM labeled data. The system obtains sample items from a catalog, predicts labels from DNN, and iteratively retrains the DNN model to improve DNN model results.

In some examples, each user is assigned a score indicating how closely the user behavior and preferences fit within a given persona. The high score indicates a persona should be assigned to the user. A low score indicates the user should be included in the persona (no assignment of the persona to the user). The personas and persona scores are used to select items for presentation and/or recommendation to the user. The system selects the top categories of items using persona scores for each user. Item carousels on merchant websites are used to present customized item recommendations to the users. Specific item carousels showing multiple items on a rotating product display carousel can be used for items such as “New in Tech” and/or “Back to School” for users belonging to related segments.

In other examples, online learning models that rank assets and items on different touchpoints across the website use persona as a feature. The system can target users with personalized recommendations based on their personas via email.

In an example, a PT level interest-based persona can include item-level personas such as, but not limited to, auto enthusiasts, beauty (male and female), cooking, baking, DIY home, fashion (female, male, and kids), home (interior and exterior), team sports, technology, and video gamer. Other personas can include lifestyle based personas, such as healthy living. Need based personas can include food, beverages, essentials, groceries, nursery, and engagement.

In other examples, PT level personas can include family-based personas. The item-level personas can include new parents, busy families, etc. A persona for pets can include item-level personas for different kinds of pets, such as dogs, cats, birds, rabbits, hamsters, fish, etc. Item-level personas for families can include age ranges for family members, such as infant, toddler (1-2), preschool (3-4), child (5-10), pre-teen (11-12), teen (13-19), etc.

In an example scenario, an untagged item has the following title: “MasterPieces Officially Licensed <Name of Sports League> <Name of Team X in the Sports League> Fan Deck Playing Cards—54 Card Deck.” The item description states, “These team playing cards are the perfect deck for all <Name of Sports League> fans! Each standard deck contains 52 cards and 2 jokers. Card-back designs feature your favorite team's logo. All face cards and jokers have detailed, custom team designs. Support your favorite team with officially licensed and approved playing cards. Perfect for all fans!” The possible set of item-level personas for the PT level of the associated sport includes the classes of (“Team W,” “Team X,” “Team Y,” “Team Z”). In this example, the DNN model outputs a prediction that the item should be labeled with the item-level persona “Team X.”

Alternatively, or in addition to the other examples described herein, examples include any combination of the following:
generate a customized recommendation for each user in the corresponding cohort of users for the item assigned the persona ID, wherein the customized recommendation is presented via a user interface (UI) device;
generate, by the GenAI model, a first set of labeled training data comprising labeled item description data for each item in a first subset of items obtained from a catalog of items, wherein the labeled item description data comprises a persona ID corresponding to a closest item-level persona selected from a first set of persona IDs for a first product type persona associated with the first subset of items, wherein each item in the first subset of items is assigned to the first product type persona, wherein the DNN model is trained to label untagged items in the catalog of items using the first set of labeled training data;
generate, by the GenAI model, a second set of labeled training data comprising labeled item description data for each item in a second subset of items from the catalog of items, wherein the labeled item description data comprises a persona ID corresponding to a closest item-level persona selected from a second set of persona IDs for a second product type persona associated with the second subset of items, wherein each item the second subset of items is assigned to the second product type persona;
generate, by the trained DNN model, a third set of labeled training data comprising labeled item description data for each item in the second subset of items; compare the second set of labeled training data to the third set of labeled training data; generate error data identifying any errors between the second set of labeled training data and the third set of labeled training data; and retrain the trained DNN model using the second set of labeled training data and the error data to increase accuracy of item-to-cohort mapping;
predict a closest item-level sub-category persona from a plurality of item-level sub-category personas associated with an item-level persona of a selected item based on item data associated with the selected item, the item data including an item description for the selected item, wherein the closest item-level sub-category persona has a greatest semantic similarity between the item description and a description of a sub-category persona in the plurality of item-level sub-category personas;
assign a persona label, including a persona ID of the closest item-level sub-category persona to the selected item;
filter all remaining item-level sub-category personas and the item-level persona associated with the product type persona of the selected item, wherein the selected item is mapped to each user in a corresponding cohort of users having a same persona ID for the same item-level sub-category persona;
create an item-level cohort associated with a plurality of users assigned to a same item-level persona;
map each user in the item-level cohort to an item having the item-level persona ID tagged to an item description for the item;
create a persona using user-related data, including transactional history data, browsing history data, and user-provided preference data, wherein the persona is customized from a general product type level down to a specific item level;
training, by a computing device, a deep neural network (DNN) model to label untagged item data using training data generated by the GenAI model, the training data comprising sample tagged item data associated with a subset of items from a plurality of items, the sample tagged item data comprising item data for each item in the subset of items labeled with a persona identifier (ID) corresponding to an item-level persona;
detecting an untagged item in the plurality of items associated with a catalog;
determining a closest item-level persona from a plurality of item-level personas associated with a product type persona of the untagged item based on item data associated with the untagged item, the item data including an item description for the untagged item, wherein the closest item-level persona has a greatest semantic similarity between the item description and a description of a persona in the plurality of item-level personas;
assigning a persona label, including a persona ID of the closest item-level persona to the untagged item;
filtering all remaining item-level personas associated with the product type persona, wherein an item assigned the persona ID is mapped to each user in a corresponding cohort of users having a same persona ID;
assigning each user in a plurality of users to a plurality of cohorts;
assigning in item in a plurality of items to a plurality of personas;
mapping each user in each cohort to at least one item assigned to a persona associated with each cohort;
generating a customized item-level recommendation for each user in each cohort using the mapping, wherein the customized item-level recommendation is presented via a user interface (UI) device;
generating, by the GenAI model, a first set of labeled training data comprising labeled item description data for each item in a first subset of items obtained from a catalog of items, wherein the labeled item description data comprises a persona ID corresponding to a closest item-level persona selected from a first set of persona IDs for a first product type persona associated with the first subset of items, wherein each item in the first subset of items is assigned to the
generating error data identifying any errors between the second set of labeled training data and the third set of labeled training data;
retraining the trained DNN model using the second set of labeled training data and the error data to increase accuracy of item-to-cohort mapping;
predicting a closest item-level sub-category persona from a plurality of item-level sub-category personas associated with an item-level persona of a selected item based on item data associated with the selected item, the item data including an item description for the selected item, wherein the closest item-level sub-category persona has a greatest semantic similarity between the item description and a description of a sub-category persona in the plurality of item-level sub-category personas;
assigning a persona label, including a persona ID of the closest item-level sub-category persona to the selected item;
disregarding all remaining item-level sub-category personas and the item-level persona associated with the product type persona of the selected item, wherein the selected item is mapped to each user in a corresponding cohort of users having a same persona ID for the same item-level sub-category persona;
creating an item-level cohort associated with a plurality of users assigned to a same item-level persona;
mapping each user in the item-level cohort to an item having the item-level persona ID tagged to an item description for the item;
calculating a similarity score for each item-level persona in the plurality of item-level personas, wherein the similarity score indicates a degree of semantic similarity between the untagged item and each of the item-level personas based on the item description for the untagged item and the description for each item-level persona; and
identifying an item-level persona having a highest similarity score; and
predicting the identified item-level persona as the greatest degree of similarity with the untagged item.
creating a persona using user-related data, including transactional history data, browsing history data, and user-provided preference data, wherein the persona is customized from a general product type level down to a specific item level;
generating, by the GenAI model, a set of labeled training data comprising labeled item description data for each item in a second subset of items from the catalog of items, wherein the labeled item description data comprises a persona ID corresponding to a closest item-level persona selected from a second set of persona IDs for a second product type persona associated with the second subset of items, wherein each item the second subset of items is assigned to the second product type persona;
generating, by the trained DNN model, a set of labeled test data comprising labeled item description data for each item in the second subset of items;
comparing the set of labeled training data to the set of labeled test data;
generating error data identifying any errors between the set of labeled training data and the set of labeled test data;
retraining the trained DNN model using the set of labeled training data and the error data to increase accuracy of item-to-cohort mapping;
assigning each user in a set of users to an item-level cohort;
mapping each user in the item-level cohort to an item having a persona label identifying an item-level persona corresponding to the item-level cohort;
generating a customized item-level recommendation for each user in the item-level cohort using the mapping, wherein the customized item-level recommendation is presented on a webpage via a UI device;
generating, by the GenAI model, labeled training data comprising a persona label identifying an item-level persona for each item in a subset of items; and
generating, by the trained DNN model, labeled test data comprising a persona label prediction identifying an item-level persona for each item in the subset of items; comparing the labeled training data to the labeled test data; identifying errors in the labeled test data using the labeled training data; calculate an error rate, wherein the DNN model is retrained if the error rate exceeds a threshold; and responsive to the error rate exceeding the threshold, retraining the trained DNN model using the labeled training data generated by the GenAI model and the error data to increase accuracy of item-to-cohort mapping;
storing the persona label with the item description in a classified items database storing tagged items for use in generating recommendations of items to users in an item-level cohort associated with the persona ID; and
store labeled item data including an item-level persona label corresponding to a tagged item in a data storage device.

At least a portion of the functionality of the various elements in FIG. 1, FIG. 2, and FIG. 3 can be performed by other elements in FIG. 1, FIG. 2, and FIG. 3, or an entity (e.g., processor 106, web service, server, application program, computing device, etc.) not shown in FIG. 1, FIG. 2, and FIG. 3.

In some examples, the operations illustrated in FIG. 5, FIG. 6, and FIG. 7 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of utilizing a generative artificial intelligence (GenAI) model for multi-level item tagging and cohort formation, the method comprising training, by a computing device, a deep neural network (DNN) model to label untagged item data using training data generated by the GenAI model, the training data comprising sample tagged item data associated with a subset of items from a plurality of items, the sample tagged item data comprising item data for each item in the subset of items labeled with a persona identifier (ID) corresponding to an item-level persona; detecting an untagged item in the plurality of items associated with a catalog; determining a closest item-level persona from a plurality of item-level personas associated with a product type persona of the untagged item based on item data associated with the untagged item, the item data including an item description for the untagged item, wherein the closest item-level persona has a greatest semantic similarity between the item description and a description of a persona in the plurality of item-level personas; assigning a persona label, including a persona ID of the closest item-level persona to the untagged item; and filtering all remaining item-level personas associated with the product type persona, wherein an item assigned the persona ID is mapped to each user in a corresponding cohort of users having a same persona ID.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

While no personally identifiable information is tracked by aspects of the disclosure, examples have been described with reference to data monitored and/or collected from the users, such as user behavior (browsing history), user profile data and/or user preference data. In some examples, notice is provided to the users of the collection of the data (e.g., via a dialog box or preference setting) and users are given the opportunity to give or deny consent for the monitoring and/or collection. The consent can take the form of opt-in consent or opt-out consent.

### Example Operating Environment

Example computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Example computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an example computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute example means for utilizing a generative artificial intelligence (GenAI) model for multi-level item tagging and cohort formation. For example, the elements illustrated in FIG. 1, FIG. 2, and FIG. 3, such as when encoded to perform the operations illustrated in FIG. 5, FIG. 6, and FIG. 7, constitute example means for training, by a computing device, a deep neural network (DNN) model to label untagged item data using training data generated by the GenAI model, the training data comprising sample tagged item data associated with a subset of items from a plurality of items, the sample tagged item data comprising item data for each item in the subset of items labeled with a persona identifier (ID) corresponding to an item-level persona; example means for detecting an untagged item in the plurality of items associated with a catalog; example means for determining a closest item-level persona from a plurality of item-level personas associated with a product type persona of the untagged item based on item data associated with the untagged item, the item data including an item description for the untagged item, wherein the closest item-level persona has a greatest semantic similarity between the item description and a description of a persona in the plurality of item-level personas; example means for assigning a persona label, including a persona ID of the closest item-level persona to the untagged item; and example means for filtering all remaining item-level personas associated with the product type persona, wherein an item assigned the persona ID is mapped to each user in a corresponding cohort of users having a same persona ID.

Other non-limiting examples provide one or more computer storage devices having a first computer-executable instructions stored thereon for providing utilizing a generative artificial intelligence (GenAI) model for multi-level item tagging and cohort formation. When executed by a computer, the computer performs operations including training, by a computing device, a deep neural network (DNN) model to label untagged item data using training data generated by the GenAI model, the training data comprising sample tagged item data associated with a subset of items from a plurality of items, the sample tagged item data comprising item data for each item in the subset of items labeled with a persona identifier (ID) corresponding to an item-level persona; detecting an untagged item in the plurality of items associated with a catalog; determining a closest item-level persona from a plurality of item-level personas associated with a product type persona of the untagged item based on item data associated with the untagged item, the item data including an item description for the untagged item, wherein the closest item-level persona has a greatest semantic similarity between the item description and a description of a persona in the plurality of item-level personas; assigning a persona label, including a persona ID of the closest item-level persona to the untagged item; and filtering all remaining item-level personas associated with the product type persona, wherein an item assigned the persona ID is mapped to each user in a corresponding cohort of users having a same persona ID.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

Likewise, the phrase “at least one,” in reference to a list of one or more elements in the specification or claims, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of’ “only one of’ or “exactly one of.” “Consisting essentially of,” when used in the claims, shall have its ordinary meaning as used in the field of patent law.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for utilizing a generative artificial intelligence (GenAI) model for multi-level item tagging and cohort mapping, the system comprising:
a processor; and
a computer-readable medium storing instructions that are operative upon execution by the processor to:
train, by a computing device, a deep neural network (DNN) model to label untagged item data using training data generated by the GenAI model, the training data comprising sample tagged item data associated with a subset of items from a plurality of items, the sample tagged item data comprising item data for each item in the subset of items labeled with a persona identifier (ID) corresponding to an item-level persona;
detect an untagged item in the plurality of items associated with a catalog;
predict a closest item-level persona from a plurality of item-level personas associated with a product type persona of the untagged item based on item data associated with the untagged item, the item data including an item description for the untagged item, wherein the closest item-level persona has a greatest semantic similarity between the item description and a description of a persona in the plurality of item-level personas;
assign a persona label, including a persona ID of the closest item-level persona to the untagged item; and
filter remaining item-level personas associated with the product type persona, wherein an item assigned the persona ID is mapped to each user in a corresponding cohort of users having a same persona ID.

2. The system of claim 1, wherein the instructions are further operative to:
generate a customized recommendation for each user in the corresponding cohort of users for the item assigned the persona ID, wherein the customized recommendation is presented via a user interface (UI) device.

3. The system of claim 1, wherein the instructions are further operative to:
generate, by the GenAI model, a first set of labeled training data comprising labeled item description data for each item in a first subset of items obtained from a catalog of items, wherein the labeled item description data comprises a persona ID corresponding to a closest item-level persona selected from a first set of persona IDs for a first product type persona associated with the first subset of items, wherein each item in the first subset of items is assigned to the first product type persona, wherein the DNN model is trained to label untagged items in the catalog of items using the first set of labeled training data.

4. The system of claim 3, wherein the instructions are further operative to:
generate, by the GenAI model, a second set of labeled training data comprising labeled item description data for each item in a second subset of items from the catalog of items, wherein the labeled item description data comprises a persona ID corresponding to a closest item-level persona selected from a second set of persona IDs for a second product type persona associated with the second subset of items, wherein each item the second subset of items is assigned to the second product type persona;
generate, by the trained DNN model, a third set of labeled training data comprising labeled item description data for each item in the second subset of items;
compare the second set of labeled training data to the third set of labeled training data;
generate error data identifying any errors between the second set of labeled training data and the third set of labeled training data; and
retrain the trained DNN model using the second set of labeled training data and the error data to increase accuracy of item-to-cohort mapping.

5. The system of claim 1, wherein the instructions are further operative to:
predicting a closest item-level sub-category persona from a plurality of item-level sub-category personas associated with an item-level persona of a selected item based on item data associated with the selected item, the item data including an item description for the selected item, wherein the closest item-level sub-category persona has a greatest semantic similarity between the item description and a description of a sub-category persona in the plurality of item-level sub-category personas;
assign a persona label, including a persona ID of the closest item-level sub-category persona to the selected item; and
filter all remaining item-level sub-category personas and the item-level persona associated with the product type persona of the selected item, wherein the selected item is mapped to each user in a corresponding cohort of users having a same persona ID for the same item-level sub-category persona.

6. The system of claim 1, wherein the instructions are further operative to:
create an item-level cohort associated with a plurality of users assigned to a same item-level persona; and
map each user in the item-level cohort to an item having the item-level persona ID tagged to an item description for the item.

7. The system of claim 1, wherein the instructions are further operative to:
create a persona using user-related data, including transactional history data, browsing history data, and user-provided preference data, wherein the persona is customized from a general product type level down to a specific item level.

8. A method for utilizing a generative artificial intelligence (GenAI) model for multi-level item tagging and cohort formation, the method comprising:
training, by a computing device, a deep neural network (DNN) model to label untagged item data using training data generated by the GenAI model, the training data comprising sample tagged item data associated with a subset of items from a plurality of items, the sample tagged item data comprising item data for each item in the subset of items labeled with a persona identifier (ID) corresponding to an item-level persona;
detecting an untagged item in the plurality of items associated with a catalog;
predicting a closest item-level persona from a plurality of item-level personas associated with a product type persona of the untagged item based on item data associated with the untagged item, the item data including an item description for the untagged item, wherein the closest item-level persona has a highest similarity score calculated based on the item description and a description of a persona in the plurality of item-level personas;
assigning a persona label, including a persona ID of the closest item-level persona to the untagged item; and
storing the persona label with the item description in a classified items database storing tagged items for use in generating recommendations of items to users in an item-level cohort associated with the persona ID.

9. The method of claim 8, further comprising:
assigning each user in a set of users to the item-level cohort;
mapping each user in the item-level cohort to an item having a persona label identifying an item-level persona corresponding to the item-level cohort; and
generating a customized item-level recommendation for each user in the item-level cohort using the mapping, wherein the customized item-level recommendation is presented on a webpage via a UI device.

10. The method of claim 8, further comprising:
generating, by the GenAI model, a first set of labeled training data comprising labeled item description data for each item in a first subset of items obtained from a catalog of items, wherein the labeled item description data comprises a persona ID corresponding to a closest item-level persona selected from a first set of persona IDs for a first product type persona associated with the first subset of items, wherein each item in the first subset of items is assigned to the first product type persona, wherein the DNN model is trained to label untagged items in the catalog of items using the first set of labeled training data.

11. The method of claim 8, further comprising:
generating, by the GenAI model, labeled training data comprising a persona label identifying an item-level persona for each item in a subset of items;
generating, by the trained DNN model, labeled test data comprising a persona label prediction identifying an item-level persona for each item in the subset of items;
comparing the labeled training data to the labeled test data;
identifying errors in the labeled test data using the labeled training data;
calculate an error rate, wherein the DNN model is retrained if the error rate exceeds a threshold; and
responsive to the error rate exceeding the threshold, retraining the trained DNN model using the labeled training data generated by the GenAI model to increase accuracy of item-to-cohort mapping.

12. The method of claim 8, further comprising:
predicting a closest item-level sub-category persona from a plurality of item-level sub-category personas associated with an item-level persona of a selected item based on item data associated with the selected item, the item data including an item description for the selected item, wherein the closest item-level sub-category persona has a greatest semantic similarity between the item description and a description of a sub-category persona in the plurality of item-level sub-category personas;
assigning a persona label, including a persona ID of the closest item-level sub-category persona to the selected item; and
filtering all remaining item-level sub-category personas and the item-level persona associated with the product type persona of the selected item, wherein the selected item is mapped to each user in a corresponding cohort of users having a same persona ID for the same item-level sub-category persona.

13. The method of claim 8, further comprising:
creating an item-level cohort associated with a plurality of users assigned to a same item-level persona; and
mapping each user in the item-level cohort to an item having the item-level persona ID tagged to an item description for the item.

14. The method of claim 8, further comprising:
creating a persona using user-related data, including transactional history data, browsing history data, and user-provided preference data, wherein the persona is customized from a general product type level down to a specific item level.

15. One or more computer storage devices having computer-executable instructions stored thereon, which, upon execution by a computer, cause the computer to perform operations comprising:
training, by a computing device, a deep neural network (DNN) model to label untagged item data using training data generated by a GenAI model, the training data comprising sample tagged item data associated with a subset of items from a plurality of items, the sample tagged item data comprising item data for each item in the subset of items labeled with a persona identifier (ID) corresponding to an item-level persona;
detecting an untagged item in the plurality of items associated with a catalog;
predicting an item-level persona from a plurality of item-level personas that has a greatest degree of similarity with the untagged item based on item data associated with the untagged item, the item data including an item title and an item description for the untagged item;
assigning a persona label, including a persona ID of the closest item-level persona to the untagged item; and
filtering all remaining item-level personas associated in the plurality of item-level personas, wherein an item assigned the persona ID is mapped to each user in a corresponding cohort of users having a same persona ID.

16. The one or more computer storage devices of claim 15, wherein the operations further comprise:
calculating a similarity score for each item-level persona in the plurality of item-level personas, wherein the similarity score indicates a degree of semantic similarity between the untagged item and each of the item-level personas based on the item description for the untagged item and the description for each item-level persona; and
identifying an item-level persona having a highest similarity score; and
predicting the identified item-level persona as the greatest degree of similarity with the untagged item.

17. The one or more computer storage devices of claim 15, wherein the operations further comprise:
generating, by the GenAI model, labeled training data comprising a persona label identifying an item-level persona for each item in a subset of items;
generating, by the trained DNN model, labeled test data comprising a persona label prediction identifying an item-level persona for each item in the subset of items;
comparing the labeled training data to the labeled test data;
identifying errors in the labeled test data using the labeled training data;
calculate an error rate, wherein the DNN model is retrained if the error rate exceeds a threshold; and
responsive to the error rate exceeding the threshold, retraining the trained DNN model using the labeled training data generated by the GenAI model.

18. The one or more computer storage devices of claim 15, wherein the operations further comprise:
predicting a closest item-level sub-category persona from a plurality of item-level sub-category personas associated with an item-level persona of a selected item based on item data associated with the selected item, the item data including an item description for the selected item, wherein the closest item-level sub-category persona has a greatest semantic similarity between the item description and a description of a sub-category persona in the plurality of item-level sub-category personas;
assigning a persona label, including a persona ID of the closest item-level sub-category persona to the selected item; and
filtering all remaining item-level sub-category personas and the item-level persona associated with the product type persona of the selected item, wherein the selected item is mapped to each user in a corresponding cohort of users having a same persona ID for the same item-level sub-category persona.

19. The one or more computer storage devices of claim 15, wherein the operations further comprise:
creating an item-level cohort associated with a plurality of users assigned to a same item-level persona; and
mapping each user in the item-level cohort to an item having the item-level persona ID tagged to an item description for the item.

20. The one or more computer storage devices of claim 15, wherein the operations further comprise:
creating a persona using user-related data, including transactional history data, browsing history data, and user-provided preference data, wherein the persona is customized from a general product type level down to a specific item level.
